(19) United States
(12) Patent Application Publication
(10) Pub. No.: US 2014/0337153 A1
(43) Pub. Date: Nov. 13, 2014

(54) EXCHANGE OF INFORMATION ABOUT GEOGRAPHICAL LOCATIONS

(71) Applicant: Constantinos Antonios Terzidis, Cambridge, MA (US)

(72) Inventor: Constantinos A. Terzidis, Cambridge, MA (US)

(21) Appl. No.: 14/333,827

(22) Filed: Jul. 17, 2014

Related U.S. Application Data
(63) Continuation-in-part of application No. 13/410,554, filed on Mar. 2, 2012, now abandoned.

(51) Int. Cl. G06Q 30/06

(52) U.S. Cl. CPC G06Q 30/0601
USPC 705/26.1

(57) ABSTRACT

According to the disclosed embodiments, information about geographical locations is traded and/or exchanged. Particularly, an indication to sell a spot, which represents one of a parking spot, a bicycle, or a taxi, may be received from a selling user. The indication may include a geographical location associated with the spot obtained by one of a webpage or a mobile device. The indication to sell the spot may further be stored in a database. After receiving the indication to sell the spot, an indication that the spot is available for purchase may be transmitted to one or more users. The indication may include the geographical location associated with the spot. Then, an indication to purchase the spot may be received from a purchasing user. After receiving the indication to purchase the spot, a transaction involving a purchase of the spot between the selling user and the purchasing user may be processed.

### CROSS-REFERENCE TO RELATED APPLICATION

This application is a continuation-in-part of U.S. application Ser. No. 13/410,554 filed on Mar. 2, 2012, the disclosure of which is herein incorporated by reference in its entirety.

### TECHNICAL FIELD

The present disclosure relates generally to computer systems, and, more particularly, to trading and/or exchanging information about geographical locations.

### BACKGROUND

The ubiquitous use of mobile devices (e.g. mobile phones, telematics, walkie-talkies, etc.) combined with the progressively more accurate geographical positioning systems (GPS) has opened new possibilities. Geographical locations can be identified easily and information about them can be broadcasted through mobile devices. This possibility can be employed for many practical purposes. For example, available parking spots can be identified and broadcasted to drivers equipped with mobile devices so that they can easily and efficiently reserve these spots. Bikers can identify their bike's drop off location so that other bikers can pick the bike up. Taxi drivers can broadcast their seats availability, and pedestrians looking for a taxi can identify their location. In general, any user of a mobile GPS/communication device can broadcast information about the user's geographical location to a network of other users equipped with mobile GPS/communication devices.

Such a technology allows users equipped with mobile GPS/communication devices to know with accuracy the location of other users also equipped with mobile GPS/communication devices and to communicate with them. Such a possibility empowers a network of users with such devices to communicate with one another in order to optimize paths, communication, reservation, trading, and coordination between geographical locations by communicating information about locations while either standing on in motion.

Utilizing the aforementioned technology, it is possible that parking spots can be traded within a geographical area. With the development of communication networks, drivers are able to arrange in advance to get parking by calling businesses to reserve a spot. Also, with the development of social networks, the ability to select a parking spot from a set of available spots using a map on a computer screen or a mobile device is possible. Conventional approaches for exchanging information relating to a parking spot include, for example, parking spaces equipped with sensors, reservation-based systems, or vehicles with an embedded GPS device. However, such conventional methods are outdated in view of current communication infrastructures. Thus, there is currently a need for a flexible, dynamic, on demand, immediate, and safe way to find or offer a spot (e.g. parking, bike, taxi seat) within a geographical area.

Such a system of exchanging information about geographical locations can provide useful for a series reasons. It is based on the premise of a sharing economy model by introducing a service, community, and trade that is beneficiary to a large set of individuals through common interest. It can thrive on the idea that my location is also your location and by sharing spaces we can both save time, money, and resources. At the same time, such an economy can produce benefits that can return back to community.

### SUMMARY

According to the disclosed embodiments, information about geographical locations is traded and/or exchanged. Particularly, an indication to post a spot, which represents one of a parking spot, a bicycle location, or a taxi seat, may be received from a posting user. The indication may include a geographical location associated with the spot obtained by one of a webpage or a mobile device. The indication of the geographical location is marked by the user and may or not correspond exactly to the actual geographical location. This indication to post the spot may further be stored in a database. After receiving the indication to post the spot, an indication that the spot is available may be transmitted to one or more users. The indication may include the geographical location associated with the spot. Then, an indication to park at the spot may be received from a seeking user. After receiving the indication to park at the spot, an exchange of information about the spot between the posting user and the parking user may be processed.

The disclosed embodiments may be seen as a social network system that can provide a multitude of benefits not only to its users but also for the city, community, environment, and economy of its applied region. Specifically, the benefits for the user can be convenience, savings, profit, and fairness. At the same time, the city, community, environment, and economy of the applied region to where the embodiments may operate can benefit tremendously. Some of the benefits can be: less pollution, money for the city, and a fair community. Moreover, the disclosed embodiments can be connected to the community to which it operates. In that capacity, it provides the community with a peace of mind over transportation and parking and makes its members more satisfied as it sets a fair way of distributing its transportation and parking resources. In addition, energy is saved, as eliminating wasteful energy is better for the economy of a country and of the world in general.

### BRIEF DESCRIPTION OF THE DRAWINGS

FIG. 1 shows a schematic diagram of a system in accordance with an embodiment of the present disclosure.

FIG. 2 shows two exemplary screenshots in accordance with an embodiment of the present disclosure.

FIG. 3 shows two exemplary screenshots of a parker mode in accordance with an embodiment of the present disclosure.

FIG. 4 shows two exemplary screenshots of a posting mode in accordance with an embodiment of the present disclosure.

FIG. 5 shows an exemplary screenshot of a selection mode in accordance with an embodiment of the present disclosure.

FIG. 6 shows two exemplary screenshots of a final confirmation process in accordance with an embodiment of the present disclosure.

FIG. 7 shows an exemplary flowchart illustrating the process of trading and exchanging information about geographical locations in accordance with an embodiment of the present disclosure.

FIG. 8 shows two exemplary screenshots of a bicycle posting mode in accordance with an embodiment of the present disclosure.

FIG. 9 shows two exemplary screenshots of a taxi posting mode in accordance with an embodiment of the present disclosure.

### DETAILED DESCRIPTION OF THE EMBODIMENTS

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the principles and features disclosed herein. Also, the disclosed system for trading and/or exchanging information (the “system”) about geographical locations (the “spots”) can provide and facilitate the exchange of data to users (“post” or “park”), for example through internet based, Geographic Positioning Systems (GPS) based, mobile device based, and integrated in-car based platforms.

The disclosed system may use GPS-equipped mobile devices (i.e. mobile phones, PDA, pads, portable computers) for communication between drivers and owners of parking spots. It may operate for a set of users that sign up to the system providing information about their self (i.e. name, address, phone), their car (i.e. license plate, car brand, car model, year, etc.), and financial information (i.e. credit card, pay pal, bank account). The system may register each user on a database that overlooks the exchange of information between users. Each exchange may consist of two modes: a) Posting a parking spot: the registered user estimates the location of a parking spot by moving a pin on the surface of a mobile/GPS device. This information is then broadcasted to the other users using the system's database through a wireless communication network. b) Parking at a spot: any of the registered users can select a parking spot that is offered by the other registered users. In this scenario, the posted parking spot has a fixed location whereas a seeking parking driver operates from a moving spot (i.e. while driving).

In an alternate exemplary embodiment, the mobile/GPS network system can be used for trading and/or exchanging information about vehicles for hire (e.g. taxicabs, shuttles, commuter buses, etc.). The system may use mobile/GPS devices to communicate information about a vehicle's for hire location and availability (i.e. number of seats, children seats, baggage space) and its destination direction. The system may register each user on a database that overlooks the exchange of information between users. A registered user may mark his/her location by using a mobile/GPS device. This information may then be broadcasted to the other users using the system's database through a wireless communication network. In one scenario, a driver broadcasts his/her location and number of available seats and a pedestrian requests a seat. In another scenario, a pedestrian broadcasts his/her location and a driver offers a seat in his/her car.

In an alternate exemplary embodiment, the mobile/GPS network system can be used for trading and/or exchanging information related to bicycle locations. The system may use mobile/GPS devices to communicate information about a bicycle's location and availability and its destination. The system may register each user on a database that overlooks the transactions between users. A registered user may mark his/her location by using a mobile/GPS device. This information may then be broadcasted to the other users using the system's database through a wireless communication network. In one scenario, a user operating a rental bike can provide the bike to another bike seeker. The provider broadcasts the location and destination of the bike. A pedestrian seeking for a bike reserves the provided bike or agrees to meet with the biker-poster at a specified location.

Furthermore, the user may be registered with at least one of a name, last name, address, phone number, car make, car model, car year, car license plate number, car license plate state, car registration expiration date, user's driver license id, and the user's credit card information. Even further, the information about a spot may be associated with at least one of a location, a time, a time range, an optional price, a destination, and an owner. Yet even further, seeking a spot may involve displaying the available parking spots on a map for the seeker to choose from. Yet even further, the selection of a spot may be obtained using at least one of a webpage, an email, a phone call, and a Short Message Service (SMS) transmission.

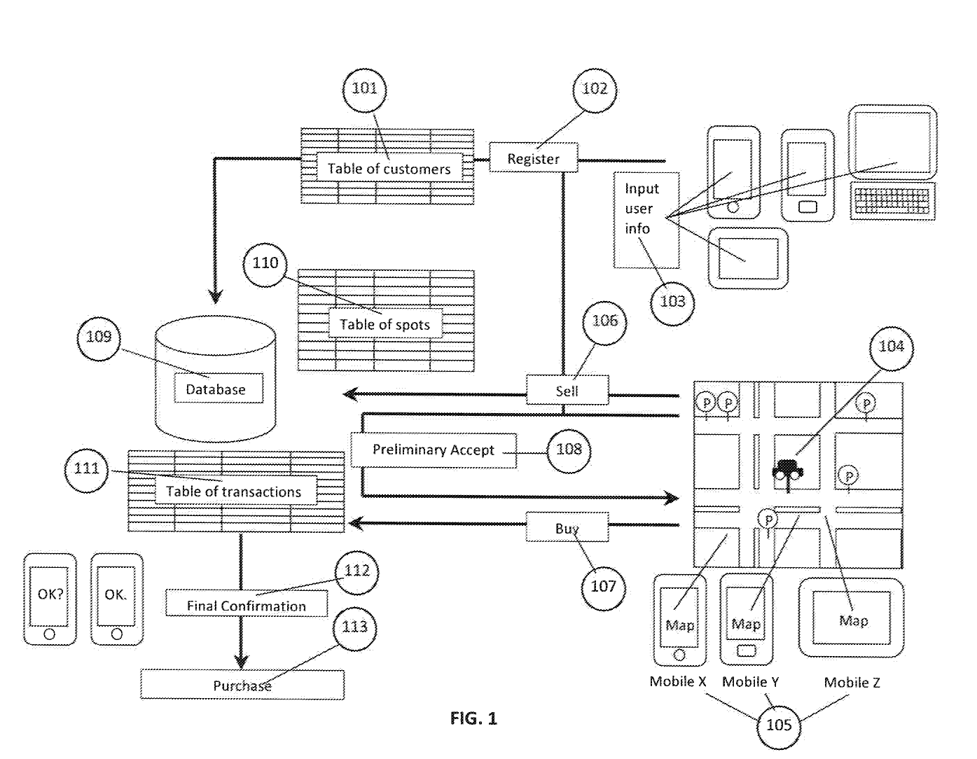

FIG. 1 shows a schematic of a system in accordance with an embodiment of the present disclosure. In particular, FIG. 1 shows a schematic of a system for trading and/or exchanging information about geographical locations in accordance with an embodiment of the present disclosure. As shown in FIG. 1, the system includes a registration mode 102, a “post” mode 106, a “park” mode 107, a preliminary acceptance mode 108, and a final confirmation mode 112. Each of these components is described in further detail below.

According to embodiments of the disclosure, registration 102 is implemented on a database 109 using a client-server architecture. More specifically, reservation system 102 may be executed on one or more servers. In addition, reservation system 102 may be accessed from other machines using a web browser and network connection. Alternatively, registration system 112 may be locally installed on a computing system, such as a personal computer (PC), mobile phone, personal digital assistant (PDA), and/or other digital computing device of the user. Information about the user-customer is represented as a data table 110 and saved, retrieved, and processed in a database 109.

The data is stored in a database located for example on a host system. The available spots may be stored in any type of storage device and in any convenient format (e.g., relational database, sequential file and persistent object). The storage of available spots is referred to herein as the database of available spots for convenience; it is not meant to imply that the only manner of storing the available spots is in a database. It will further be appreciated by those skilled in the art that while the system depicts a single host server with a database 109, the embodiments are capable of using one or more servers. The skilled artisan will understand that the addition of more than one server does not affect application of the present disclosure.

Those skilled in the art will understand that a user can identify his or her geographical location by using the GPS (Geographical Positioning System) that can provide, among other information, the latitude and longitude of the user's GPS-equipped mobile device location (i.e. the GPS coordinates) 104. This information can be seen on a map that is displayed on the screen of a mobile device (e.g. phone, telematics, PDA, pad, etc.) including, but not limited to: pad, smart phone, GPS 105. The mapping software may be implemented by any commercial software package, including, but not limited to: TomTom Go Portable Navigation, Garmin StreetPilot 2620 GPS Portable Car Navigation, and Apple's mapkit framework. Those skilled in the art will understand that the GPS coordinates can be mapped to a physical address through a process referred to as reverse geocoding. Information related to the position (i.e. latitude, longitude, and altitude) together with other information (e.g. time, price, owner id, parker id, address, features, etc.) is represented as a data table 110 and is saved, retrieved, and processed through a database 109.

GPS is used as an example of a geographic location system and the present disclosure is not limited to the use of a GPS system and GPS coordinates, but could also be implemented using any system for identifying approximate geographic locations. The geographic indicators may be received on a nearly continuous basis from vehicles and other traffic devices in order to keep the database of available spots as real time as possible. The more frequent the updates from the vehicles and traffic devices, the more accurate the data in the database of available spots. In addition, the more sources of GPS locations, the more cross checking that can be performed which may lead to a more accurate assessment of available spots.

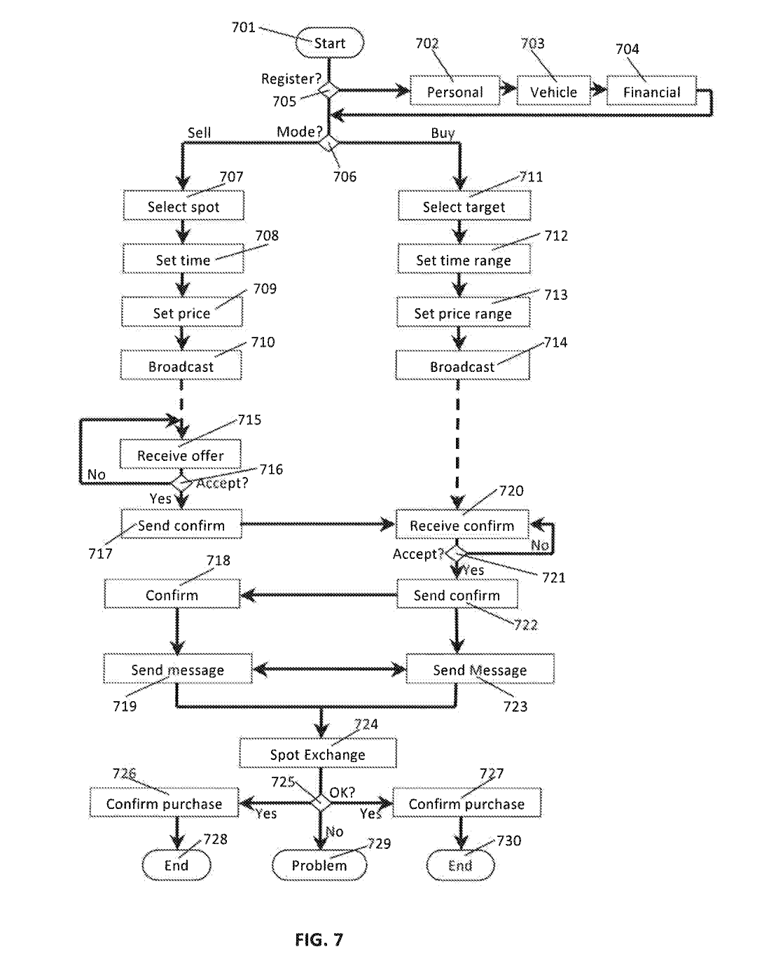

After identifying the user's GPS mobile device location, the user then can enter two modes: post or park. In the “post” mode 106 the user offers the estimated geographical location (a.k.a. spot), by broadcasting the database information about the spot 110 to the network. This is done through wireless communication supported by the mobile device and the user's phone and/or Internet carrier. In the “park” mode 107 the user selects a geographical location (a.k.a. spot) from a list of spots acquired from the available data tables of the database. Specifically, a desired geographical location together with other information within the table 110 is broadcasted from the user-parker GPS-equipped mobile device. The broadcasted message is received by a receptor (e.g. a server), and then the database is searched for available spot or spots within a particular proximity of the desired geographical location. If an available spot or spots within a particular proximity of the desired geographic location is located in the database, a message containing the tables of the available spots is broadcasted back to the parker's mobile device. This is done through wireless communication supported by the mobile device and the user's phone and/or Internet carrier. The user-parker then may view the available spots on a map displayed on a mobile device and then chooses a spot from the list of available spots. Alternatively, the user's steps described above may be performed using an Internet-connected computer, e.g., via a webpage. This process is described in more detail in the following paragraphs of this document especially in the flowchart description of FIG. 7.

Once the user-parker requests a spot, and the user-poster accepts that request 108, then a preliminary acceptance is established by entering information about the transaction (e.g. date, spot id, poster, parker, etc.) in a table 111 at the database 109. Once the actual spot offered by the user-poster is physically occupied by the user-seeker, then the transaction is final 112, and a successful exchange of information can be confirmed 113. Such a verification of final transaction can be accomplished by various means (e.g. communication between the poster and seeker, detection on the server of enough physical proximity between the GPS coordinates of poster's and parker's locations at the same time, etc.) If there are no problems then the process is ended.

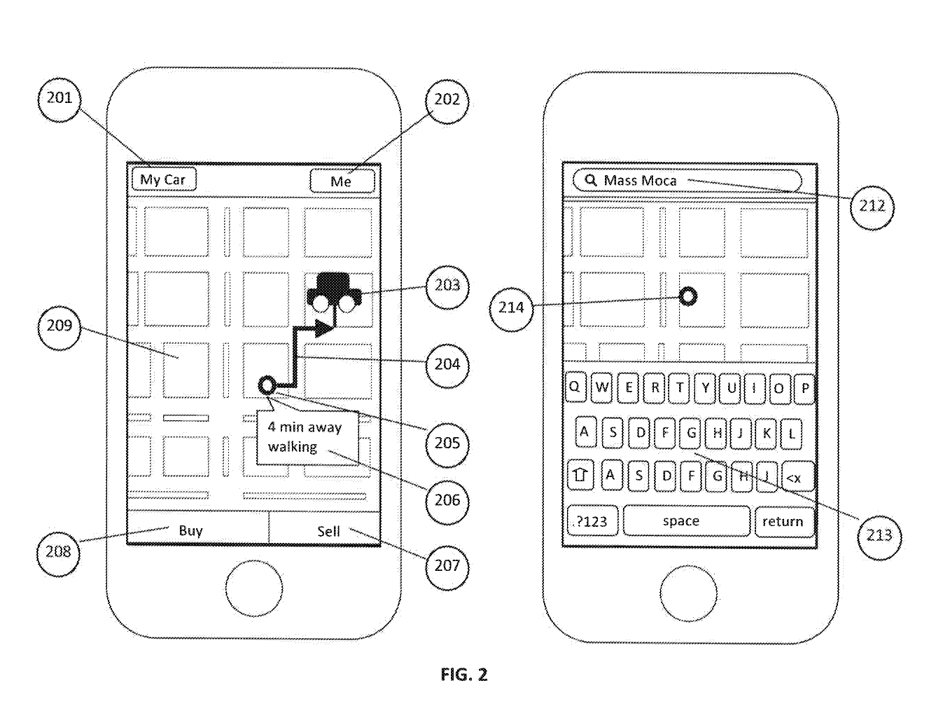

FIG. 2 shows an exemplary screenshot in accordance with an embodiment of the present disclosure. In particular, FIG. 2 shows two screenshots: one of a vehicle and the other of a destination spot identification process based on a map 208. In this example, a user's location is identified with a mark shown here as a black circle 205. The vehicle's location is marked by the user with a pin in the shape of a car 203. A polyline 204 ending with an arrow shows an exemplary path that starts from the user's location and ends with the vehicle's location. An annotation provides information about the vehicle's location to the user (e.g. “4 min away walking”) 206. In particular, the annotation indicates that the user is 4 minutes away from the vehicle in walking time. An alternate possibility is to indicate the distance in feet.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, motorcycles, and the like, and includes hybrid vehicles, electric vehicles, plug-in hybrid electric vehicles, hydrogen-powered vehicles and other alternative fuel vehicles (e.g. fuels derived from resources other than petroleum).

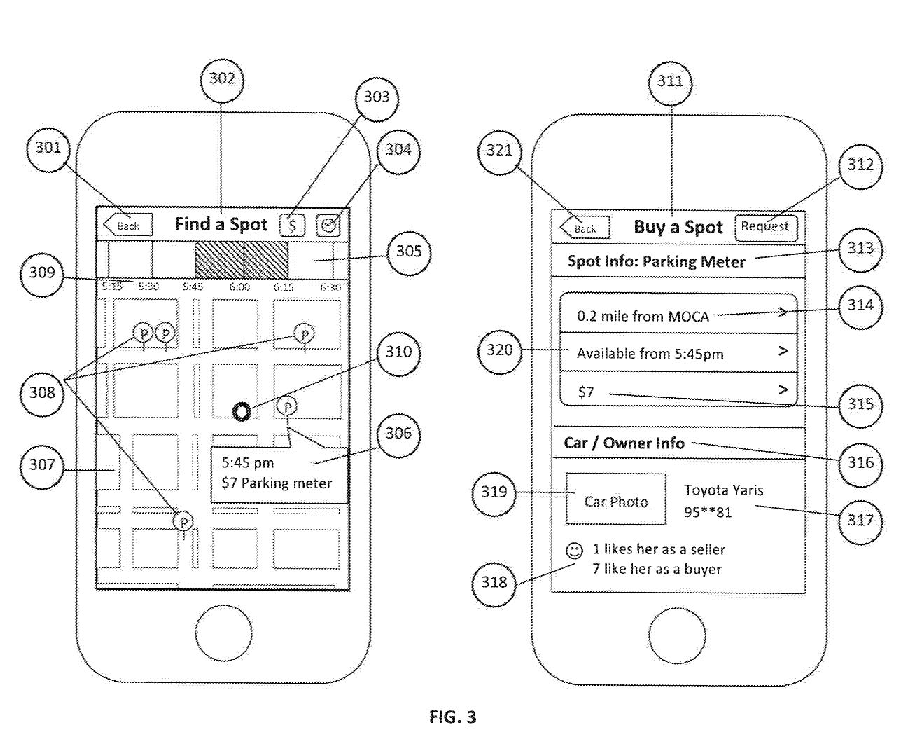

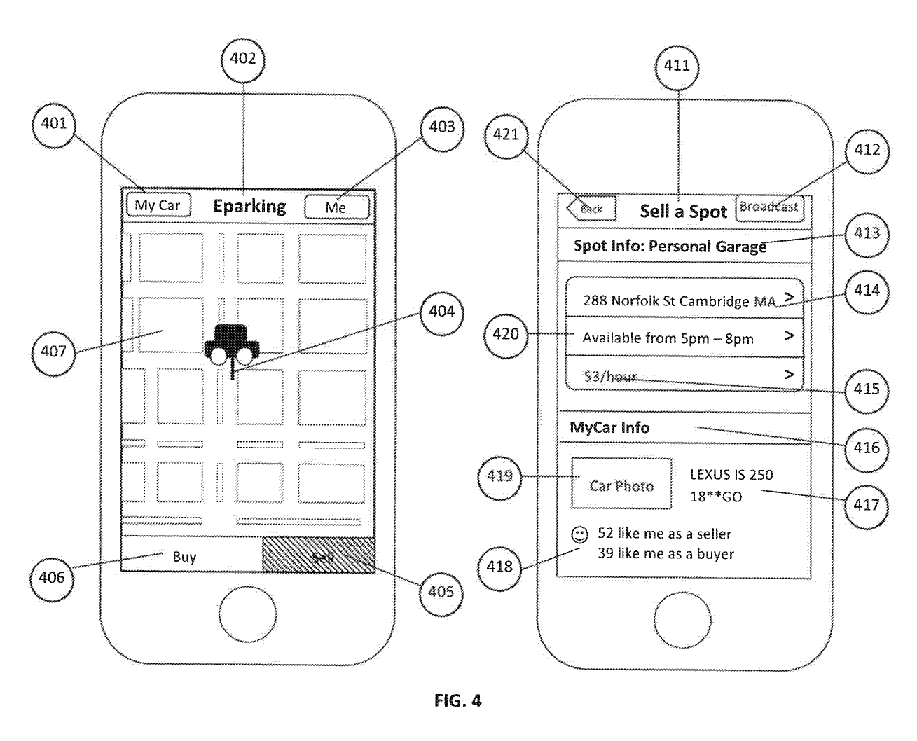

The user interface is composed of a map 209 that shows the geographical region within which the vehicle and its user are located. The user may identify his or her location 205 by selecting a button (e.g. “Me”) 202. The user may identify his or her vehicle location 203 by selecting a button (e.g. “My Car”) 201. The user can enter the “park” mode (described in FIG. 3) by selecting a button (e.g. “Park”) 208, or the user can enter the “post” mode (described in FIG. 4) by selecting a button (e.g. “Post”) 207.

In the next screenshot, a user can select a destination 214 by at least one of the following ways: by selecting the location on a map displayed on the GPS-equipped mobile device using a pointer (e.g. cursor, mouse, tap on a touch screen), and typing 212 the destination address or any other information related to the address using an input device (e.g. keyboard) 213.

FIG. 3 shows an exemplary screenshot in accordance with an embodiment of the present disclosure. In particular, FIG. 3 shows two screenshots of a mobile device that illustrate the “park” mode. In this example, the user enters this mode by selecting a button (e.g. “Park”) 208 as described in FIG. 2. The user can return back to the previous screen by selecting a button (e.g. “Back”) 301. In this mode, the user is presented with a map 307 that shows the user's target location 310. The target location is obtained by geocoding the address typed in by the user. (Geocoding is referred to as the process of finding the geographical location from geographical data, such as address, zip code, etc. This process is available as a third party service.) The location of the target, that is, the user's destination location 310 is shown at the center of the map 307. The user can also see all the available parking spots to choose from 308. By selecting any parking spot 308 on the map 307, the user can invoke specific information about the selected spots (e.g. the time the parking spot is available, the price, and/or other information). The user also can input, by selecting a button 304, a time range that he or she is looking for parking, and the system will show only the available parking spots for that time range. The user has the option to input, by selecting a button 303, a money range that he or she is looking to pay for parking, and the system will show only the available parking spots for that money range. For the purposes of the present disclosure, the term “parking spot” may encompass any suitable location for parking a vehicle. The parking spot may be located at, for example, a lot, a driveway, a garage, a street-side, and the like.

Once the user selects an available parking spot, then a screen is displayed (e.g. titled “Park” 311) that allows the user to see more information about the spot 313 and its owner 316, and then request the spot by selecting a button (e.g. “Request”) 312. Information about the spot can be shown in one section of the screen 313. More specifically, information about the type of parking 313 (e.g. “Parking Meter”), its distance 314 (e.g. “0.2 miles from MOCA”), its time availability 320 (e.g. “Available from 5:45 pm”), and/or its optional price 317 (e.g. $0) is displayed. Further, information about the car and the owner of the spot can be shown in another section of the screen 316. More specifically, information about the type of car 317 (e.g. “Toyota Yaris”), its license plate 317 (e.g., 95**81), a photo of the car 319, and the popularity and prestige of the car owner 318 (e.g. 1 likes her as a poster” and “7 like her as a parker”) is displayed.

FIG. 4 shows an exemplary screenshot in accordance with an embodiment of the present disclosure. In particular, FIG. 4 shows two screenshots of a mobile device that illustrate the posting mode. In this example, the user enters this mode by selecting a button (e.g. titled “Post”) 207 as described in FIG. 2. The user can return back to the previous screen by selecting a button (e.g. titled “Back”) [[401]]421. In this mode, the user is presented with a map 407 that shows the user's present location 404. The user can also invoke his or her location by selecting a button 403 (e.g. titled “Me”). If, for some reason, the car's location 404 is not displayed in the screen 407, then the user can invoke the car's location by selecting a button 401 (e.g. titled “My Car”). After that the user can enter the next posting mode screen by selecting a button 405 (e.g. titled “Post”).

Once the user selects to offer a parking spot, then a screen is displayed (e.g. titled “Post” 411) that allows the user to edit information about the spot 413 and the car 416, and then broadcast that information to the network by selecting a button (e.g. “Broadcast”) 412. Information about the spot can be shown in one section of the screen 413. More specifically, information about the type of parking 413 (e.g. “Personal Garage”), its address 414 (e.g. “288 Norfolk St Cambridge Mass.”), its time availability 420 (e.g. “Available from 5 pm-8 pm”), and/or its optional price 415 (e.g. $0/hour) is displayed and can be edited. Further, information about the car and the owner of the spot can be shown in another section of the screen 416. More specifically, information about the type of car 417 (e.g. “LEXUS IS 250”), its license plate 417 (e.g., 18**GO), a photo of the car 419, and the popularity and prestige of the car's owner 418 (e.g. 52 like me as a poster” and “39 like me as a parker”) is displayed.

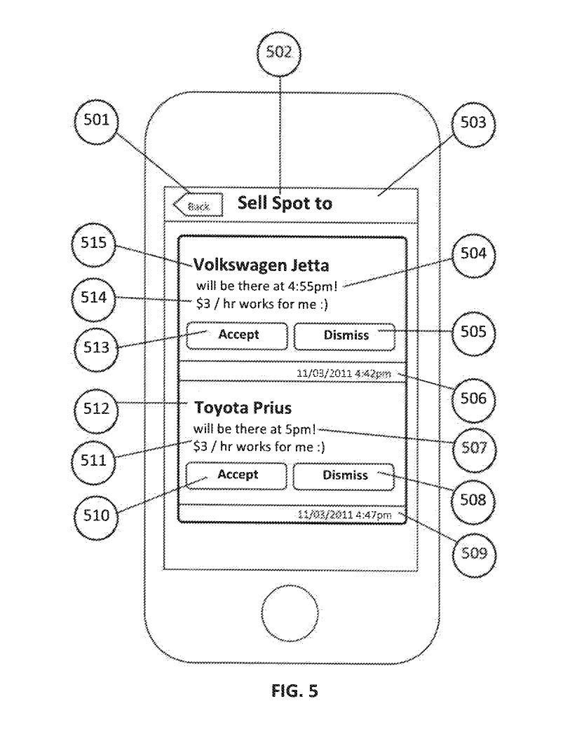

FIG. 5 shows an exemplary screenshot in accordance with an embodiment of the present disclosure. In particular, FIG. 5 shows one screenshot of a mobile device that illustrates the phase of selection mode where the poster, after he or she broadcasts the parking spot's availability, receives requests from parkers. In this example, the user receives requests from a parker or parkers that are listed in chronological order 515, 512, etc. For each request, related information is displayed. In particular, information about the type of car (e.g. “Volkswagen Jetta” 515 or “Toyota Prius” 512), a brief message from the potential parker (e.g. “will be there at 4:55 pm!” 504 or “will be there at 5 pm!” 507), and a message about the optional price (e.g. “$0/hr works for me [symbol] ” 511 or “$0/hr works for me [symbol] ”), together with the time and date that the request or requests were sent (e.g. “11/03/2011 4:42 pm” 506 or “11/03/2011 4:47 pm” 509), may be displayed. The user is then given two choices: either to accept (e.g. select a button titled “Accept” 513, 510) or to dismiss (e.g. select a button titled “Dismiss” 505, 508).

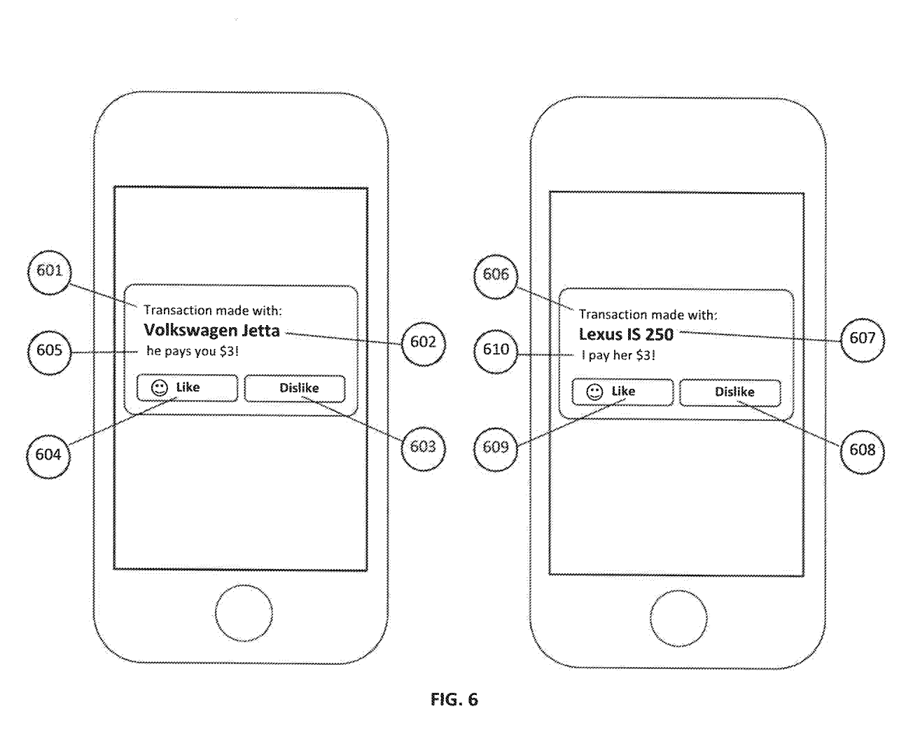

FIG. 6 shows an exemplary screenshot in accordance with an embodiment of the present disclosure. In particular, FIG. 6 shows two screenshots of a mobile device that illustrate the final confirmation process. In this example, the user-poster receives a message for the user-parker that confirms the transaction (e.g. “Exchange made with:” 601) with the type of car the exchange was made with (e.g. “Volkswagen Jetta” 602), and the optional price (e.g. “he gives you $0!” 605). Then, the user-poster can have a choice to like or dislike the user-parker (e.g. select a button titled “Like” 604 or “Dislike” 603).

Reversely, the user-parker receives a message for the user-poster that confirms the exchange (e.g. “Exchange made with:” 606) with the type of car the exchange was made with (e.g. “Lexus IS 250” 607), and the optional price (e.g. “I gave her $0!” 610). Then, the user-parker can have a choice to like or dislike the user-poster (e.g. select a button titled “Like” 609 or “Dislike” 608).

FIG. 7 shows a flowchart illustrating the process of exchanging information about geographical locations in accordance with an embodiment of the present disclosure. According to the embodiments, one or more of the steps may be omitted, repeated, and/or performed in a different order. Accordingly, the specific arrangement of steps shown in FIG. 7 should not be construed as limiting the scope of the invention.

Initially, the user is presented with a starting screen (e.g. a map 701). If it is the first time, the user is asked to register by supplying information about him self or her self (e.g. in a category titled “Personal” 702), about the vehicle (e.g. in a category titled “Vehicle” 703), and/or financial (e.g. in a category titled “Financial” 704). After that, the user has a choice 705 of entering into a Post mode or a Park mode. If Post mode is entered, then the user is prompted to select a spot to offer 707 (e.g. by selecting a point in a map or entering an address), set a time that the spot is available 708, set an optional price for the spot 709 and then broadcast that information to the network. If Park mode is entered, then the user is prompt to select a target spot 711 (e.g. by selecting a point in a map or entering an address), set a time range that he or she wants the spot 712, set an optional price range that the user offers for that spot 713 and then broadcast that information to the network 714.

If the user-poster receives an offer from a user-parker 715, then the user-poster has a choice 716 to accept or reject that offer. If the user-poster rejects the offer, then the system expects a new offer from a user-parker. If the user-poster decides to accept the offer from the user-parker 716, then the user-poster sends a confirmation message to the user-parker 717. As the user-parker receives a confirmation of the offer, the user-parker has a choice 721 to accept or reject the confirmation from the user-poster. If the user-parker rejects the offer, then the system expects a new offer from another user-poster. If the user-parker decides to accept the offer from the user-poster 716, then the user-parker sends a confirmation message to the user-poster 718. This confirmation initiates a preliminary acceptance that will be finalized only when the poster and the parker physically exchange geographical locations.

In the time between the preliminary and the final deal, the poster and the parker can communicate (e.g. text message, email, etc.) to update and inform either party about the progress of the encounter and/or possible problems (i.e. traffic, accidents, change of mind, etc.) Both users can see each other location during the waiting time using GPS enabled devices. The user-poster can send a message 719 to the user-parker, and reversely, the user-parker can send a message 723 to the user-poster.

Once the system confirms the physical exchange between the user-poster and the user-parker 724, then if there is no problem 725, a message is sent to the user-poster indicating that the deal was successful, and an exchange was confirmed 726. This will end the process for the user-poster party 728. In some embodiments, an evaluation of the poster about the behavior of the parker party is possible. Similarly, a message is sent to the user-parker indicating that the deal was successful, and an exchange was confirmed 727. This will end the process for the user-parker party 730. In some embodiments, an evaluation of the poster about the behavior of the parker party is possible. If a problem was encountered, then a termination occurs 729.

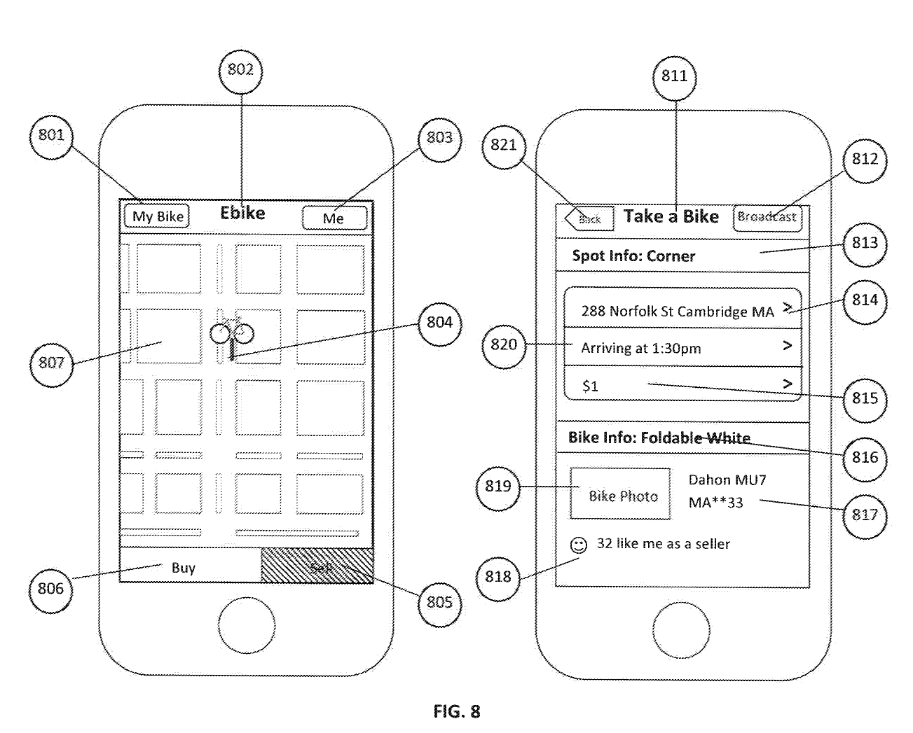

FIG. 8 shows an exemplary screenshot in accordance with an embodiment of the present disclosure. In particular, FIG. 8 shows two screenshots of a mobile device that illustrate the posting mode for a bike. In this example, the user is presented with a map 807 that shows the user's bike present location 804. The user can also invoke his or her location by selecting a button 803 (e.g. titled “Me”). If, for some reason, the bike's location 904 is not displayed in the screen 807, then the user can invoke the bike's location by selecting a button 801 (e.g. titled “My Bike”). After that, the user can enter the next posting mode screen by selecting a button 805 (e.g. titled “Post”). For the purposes of the present disclosure, the term “bike” or “bicycle” may encompass any suitable pedal-driven vehicle, including, for example, unicycles, tricycles, and the like.

Once the user selects to offer a bike, then a screen is displayed (e.g. titled “Take a Bike” 811) that allows the user to edit information about the spot 813 and the bike 816, and then broadcast that information to the network by selecting a button (e.g. “Broadcast”) 812. Information about the spot can be shown in one section of the screen 813. More specifically, information about the type of spot 813 (e.g. “Corner”), its address 814 (e.g. “288 Norfolk St Cambridge Mass.”), its time availability 820 (e.g. “Arriving at 1:30 pm”), and/or its price 817 (e.g. “$0”) is displayed and can be edited. Further, information about the bike and the owner of the spot can be shown in another section of the screen 816. More specifically, information about the type of bike 817 (e.g. “Dahon MU7”), its license plate or bike ID 817 (e.g., “MA*33”), a photo of the bike 819, and the popularity and prestige of the bike's owner 818 (e.g. “32 like me as a poster”) may be displayed.

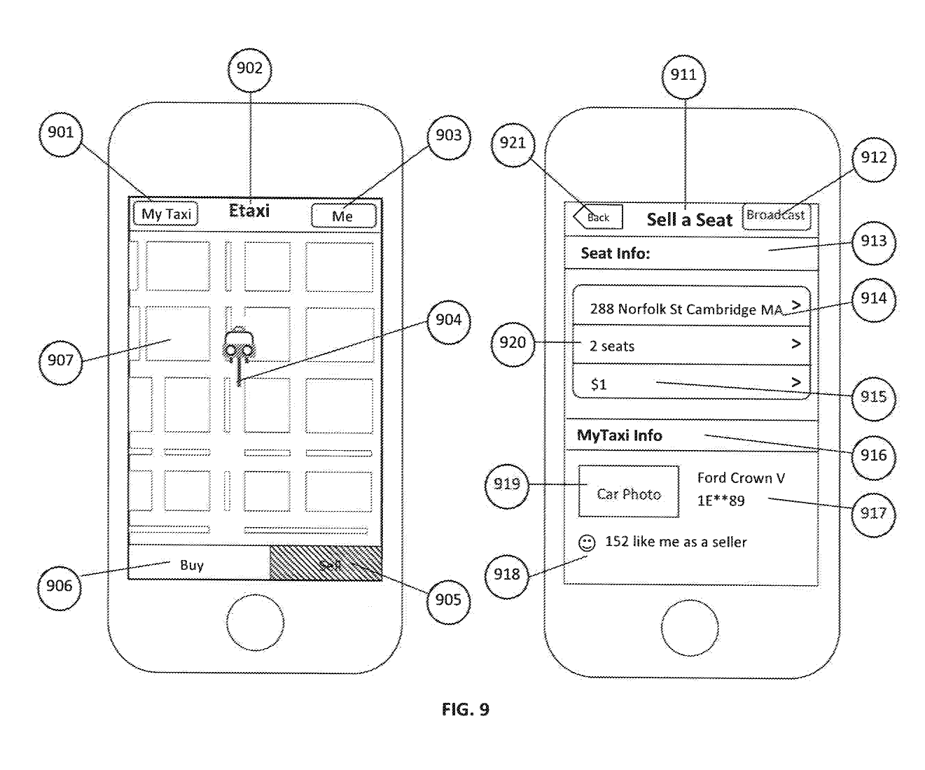

FIG. 9 shows an exemplary screenshot in accordance with an embodiment of the present disclosure. In particular, FIG. 9 shows two screenshots of a mobile device that illustrate the posting mode for a taxi. In this example, the user is presented with a map 907 that shows the user's present location 904. The user can also invoke his or her location by selecting a button 903 (e.g. titled “Me”). If, for some reason, the taxi's location 904 is not displayed in the screen 907, then the user can invoke the taxi's location by selecting a button 901 (e.g. titled “My Taxi”). After that, the user can enter the next posting mode screen by selecting a button 905 (e.g. titled “Post”). For the purposes of the present disclosure, the term “taxi” or “cab” may encompass any suitable vehicle-for-hire, including, for example, buses, “bike taxis,” commuter vehicles, and the like.

Once the user selects to offer a seat, then a screen is displayed (e.g. titled “Post a Seat” [[811]]911) that allows the user to edit information about the seat 913 and the taxi 916, and then broadcast that information to the network by selecting a button (e.g. “Broadcast”) 912. Information about the spot can be shown in one section of the screen 913. More specifically, information about the type of seat 913 (e.g. “Corner”), its address 914 (e.g. “288 Norfolk St Cambridge Mass.”), its seat availability 920 (e.g. “2 seats”), and/or its price 917 (e.g. “$0”) is displayed and can be edited. Further, information about the taxi and the owner of the spot can be shown in another section of the screen 916. More specifically, information about the type of bike 917 (e.g. “Ford Crown V”), its license plate 917 (e.g., “1E**89”), a photo of the taxi 919, and the popularity and prestige of the taxi's owner 918 (e.g. “152 like me as a poster”) may be displayed.

Those skilled in the art will appreciate that the two last figures, i.e. FIG. 8 and FIG. 9, are variations of the general scheme described as a flowchart in FIG. 7. In both cases, the difference is only superficial, i.e. in the names of the screens (e.g. “Spot” is replaced with “Seat” or “Car” is replaced with “Taxi” or “Bike”). In essence, the system operates the same way and only the labels changes.

As mentioned in the beginning of this section, the foregoing descriptions of embodiments of the present disclosure have been presented only for purposes of illustration and description. They are not intended to be exhaustive or to limit the present disclosure to the forms disclosed. Accordingly, many modifications and variations will be apparent to practitioners skilled in the art. Additionally, the above disclosure is not intended to limit the present invention. The scope of the present invention is defined by the appended claims.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, Solid State Drives (SSD), CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a mobile device that contains a computer system reads and executes the code and/or data stored on the computer-readable storage medium, the computer system performs the methods and processes embodied as data structures and code and stored within the computer-readable storage medium. Additionally, it is understood that the above methods and processes are executed by at least one controller/computer. The term “controller” or “computer” refers to a hardware device that includes a memory and a processor. The memory is configured to store program instructions, and the processor is specifically configured to execute said program instructions to perform one or more processes, which are described further above.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Those skilled in the art will appreciate that the registration, parking, posting, preliminary acceptance, and final confirmation modes of the system 102, 106, 107, 108, 112 may interact with the users through a variety communications media. In other words, access to customer user interface 103, 105 may not be restricted to standard user interfaces for applications, such as GUIs or web-based user interfaces. As a result, the user may also access customer user interface 103, 105 through mechanisms such as email, phone calls, Short Message Service (SMS) transmissions and/or push notifications. For example, a user may interact with preliminary acceptance system 108 by sending an email or Push Notification message containing a set of keywords for confirming interest in a spot in lieu of loading a webpage in a web browser or running an application installed on a mobile device. Along the same lines, the user may issue voice commands to an interactive voice response (IVR) system during a phone call instead of transmitting text data during the preliminary acceptance phase 108.

As described above, the embodiments of the disclosure may be embodied in the form of hardware, software, firmware, or any processes and/or apparatuses for practicing the embodiments. The embodiments may also be embodied in the form of computer program code containing instructions embodied in tangible media, such as flash drives, CD-ROMs, hard drives, or any other computer-readable storage medium, wherein, when the computer program code is loaded into and executed by a computer, the computer becomes an apparatus for practicing the embodiments. The embodiments can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the embodiments. When implemented on a general-purpose microprocessor, the computer program code segments configure the microprocessor to create specific logic circuits.

While the contents of the present disclosure have been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this invention, but that the disclosure will include all embodiments falling within the scope of the appended claims. Moreover, the use of the terms first, second, etc. do not denote any order or importance, but rather the terms first, second, etc. are used to distinguish one element from another.

The disclosure extends to computer programs in the form of source code, object code, code intermediate sources and object code (such as in a partially compiled form), or in any other form suitable for use in the implementation of the embodiments. Computer programs are suitably standalone applications, software components, scripts or plug-ins to other applications. Computer programs embedding the embodiments are advantageously embodied on a carrier, being any entity or device capable of carrying the computer program: for example, a storage medium such as ROM or RAM, optical recording media such as CD-ROM or magnetic recording media such as floppy discs. Computer programs may be suitably downloaded across the Internet from a server. Computer programs are also capable of being embedded in an integrated circuit. Any and all such embodiments containing code that will cause a computer to perform substantially the principles as described herein, will fall within the scope of the embodiments.

The foregoing description of a preferred embodiment of the disclosure has been presented for purposes of illustration and description. It is not intended to be exhaustive or to limit the disclosure to the precise form disclosed. Obvious modifications or variations are possible in light of the above teachings. The embodiment was chosen and described to provide the best illustration of the principles of the disclosure and its practical application to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally and equitably entitled.

What is claimed is:

1. A method, comprising:
receiving, from a selling user, an indication to sell a spot, the indication including a geographical location associated with the spot obtained by one of a webpage or a mobile device, wherein the spot represents one of a parking spot, a bicycle, or a taxi;
storing the indication to sell the spot in a database;
transmitting, to one or more users, an indication that the spot is available for purchase, the indication including the geographical location associated with the spot;
receiving, from a purchasing user, an indication to purchase the spot; and
processing a transaction involving a purchase of the spot between the selling user and the purchasing user.

2. The method of claim 1, further comprising:
registering a plurality of users into a system that allows communication between registered users, wherein
the selling user and the purchasing user are registered users.

3. The method of claim 2, further comprising:
receiving, from a user to be registered, at least one of a name, a last name, an address, a phone number, a license plate number, a driver license number, a credit card number, and an identification card.

4. The method of claim 1, wherein the indication to purchase the spot includes at least one of a geographical location, an address, a time range, and a price range.

5. The method of claim 1, wherein the indication to sell the spot further includes at least one of a time, a duration, and a price.

6. The method of claim 1, wherein the indication that the spot is available for purchase is transmitted so as to be displayed on a map for viewing by the one or more users.

7. The method of claim 1, further comprising:
facilitating communication between the selling user and the purchasing user, the communication being performed using at least one of an Internet message (TCP/IP), an email, a phone call, and a Short Message Service (SMS) transmission.

8. The method of claim 1, further comprising:
receiving, from the purchasing user, an indication of a destination, the indication including a geographical location associated with the destination obtained by one of a webpage or a mobile device;
determining one or more spots stored in the database within a predetermined proximity of the destination; and
transmitting, to the purchasing user, an indication of the one or more spots, the indication including a geographical location associated with each spot.

9. A system, comprising:
a selling device that is configured to transmit an indication to sell a spot, the indication including a geographical location associated with the spot obtained by one of a webpage or a mobile device, wherein the spot represents one of a parking spot, a bicycle, or a taxi;
a purchasing device that is configured to transmit an indication to purchase the spot; and
a controller that is configured to:
receive the indication to sell a spot from the selling device,
receive the indication to purchase the spot from the purchasing device,
store the indication to sell the spot in a database,
transmit, to one or more users, an indication that the spot is available for purchase, the indication including the geographical location associated with the spot, and
process a transaction involving a purchase of the spot between the selling device and the purchasing device.

10. The system of claim 9, wherein:
the controller is further configured to register a plurality of users into a system that allows communication between registered users, and
the selling device and the purchasing device are respectively operated by registered users.

11. The system of claim 9, wherein the indication to purchase the spot includes at least one of a geographical location, an address, a time range, and a price range.

12. The system of claim 9, wherein the indication to sell the spot further includes at least one of a time, a duration, and a price.

13. The system of claim 9, wherein the purchasing device is further configured to:
receive the indication that the spot is available for purchase, and
display an indication of the spot on a map.

14. The system of claim 9, wherein the controller is further configured to facilitate communication between the selling device and the purchasing device, the communication being performed using at least one of an Internet message (TCP/IP), an email, a phone call, and a Short Message Service (SMS) transmission.

15. The system of claim 9, wherein:
the purchasing device is further configured to transmit an indication of a destination, the indication including a geographical location associated with the destination obtained by one of a webpage or a mobile device, and
the controller is further configured to:
receive the indication of the destination from the purchasing device,
determine one or more spots stored in the database within a predetermined proximity of the destination, and
transmit, to the purchasing device, an indication of the one or more spots, the indication including a geographical location associated with each spot.

16. A non-transitory computer-readable medium storing program instructions executable by a controller, the computer readable medium comprising:
program instructions that receive, from a selling user, an indication to sell a spot, the indication including a geographical location associated with the spot obtained by one of a webpage or a mobile device, wherein the spot represents one of a parking spot, a bicycle, or a taxi;
program instructions that store the indication to sell the spot in a database;
program instructions that transmit, to one or more users, an indication that the spot is available for purchase, the indication including the geographical location associated with the spot;
program instructions that receive, from a purchasing user, an indication to purchase the spot; and
program instructions that process a transaction involving a purchase of the spot between the selling user and the purchasing user.

17. The computer readable medium of claim 16, further comprising:
program instructions that register a plurality of users into a system that allows communication between registered users, wherein
the selling user and the purchasing user are registered users.

18. The computer readable medium of claim 16, wherein the indication to purchase the spot includes at least one of a geographical location, an address, a time range, and a price range.

19. The computer readable medium of claim 16, wherein the indication to sell the spot further includes at least one of a time, a duration, and a price.

20. The computer readable medium of claim 16, further comprising:
program instructions that receive, from the purchasing user, an indication of a destination, the indication including a geographical location associated with the destination obtained by one of a webpage or a mobile device;
program instructions that determine one or more spots stored in the database within a predetermined proximity of the destination; and
program instructions that transmit, to the purchasing device, an indication of the one or more spots, the indication including a geographical location associated with each spot.
